(19) United States
(12) Patent Application Publication
(10) Pub. No.: US 2007/0020019 A1
(43) Pub. Date: Jan. 25, 2007

(54) Writing instrument with a partially resilient end

(76) Inventor: Edward Goldberg, Teaneck, NJ (US)

Correspondence Address: KAPLAN GILMAN GIBSON & DERNIER L.L.P., 900 ROUTE 9 NORTH, WOODBRIDGE, NJ, 07095, US

(21) Appl. No.: 11/283,204

(22) Filed: Nov. 18, 2005

Related U.S. Application Data
(63) Continuation-in-part of application No. 11/132,700, filed on May 19, 2005.

(51) Int. Cl. A46B 5/02; B43K 29/00

(52) U.S. Cl. 401/6; 401/195

(57) ABSTRACT

A writing instrument comprises a first end portion having a writing point and a grasping portion, and a second end portion opposite to the first end portion having a plunger member. The plunger member may include an inner member and a non-rigid cover for the inner member. The plunger cover and grasping portion are preferably made of a partially resilient material. The plunger and grasping portion are replaceable without causing damage to the writing instrument, and are preferably matching in appearance. A kit including the writing instrument and, preferably, multiple pairs of plunger covers and grasping portions are also envisioned.

### RELATED APPLICATIONS

This application is a continuation-in-part of co-pending patent application Ser. No. 11/132,700, filed May 19, 2005, and entitled “A Writing Instrument with a Resilient End,” which is incorporated herein by reference.

### BACKGROUND OF THE INVENTION

The invention relates to writing instruments, and more particularly, to a writing device having a partially resilient end which may be of a two part construction.

Writing instruments having a rigid plunger are known in the art. Such plungers are made of a rigid plastic or metal, precious or otherwise. When such writing instruments also have gripping portions made of material other then the material of the rigid plunger, as for example a rubber or rubber-like material, the gripping portion and the plunger do not match in color, texture and/or sometimes, pattern. Therefore, it would be desirable to provide a writing instrument wherein the plunger and gripping portion have the same look and feel. It would also be desirable to allow for the plunger and/or gripping portion to be selectively interchangeable with other plungers and/or gripping portions so as to allow for the selective variation of the coloring of the writing instrument and/or the texture of the gripping portion and/or the patterns of these elements.

### SUMMARY OF THE INVENTION

The present invention provides a novel writing instrument which comprises a first end portion having a writing point and a second end portion opposite to the first end portion, wherein the second end portion is capable of partially resiliently deforming under an external force.

Preferably, the second end portion has a plunger for driving the writing point to reciprocally move between an exposed, writing position and a retracted, non-writing position.

In a preferred embodiment the writing instrument has a plunger preferably comprising two parts; an inner, substantially rigid member, and an outer, substantially pliable and/or flexible cover, wherein the flexibility of the cover allows for the plunger to be partially resilient.

In another preferred embodiment, the grasping/gripping (“grasping” and gripping” are interchangeably used throughout this document) portion of the writing instrument and the outer cover of the plunger are made of the same material, having the same texture, coloring and pattern. In such an embodiment, one achieves an aesthetically pleasing look to the overall look and feel of the writing instrument, and thereby adds value to the same.

In yet a further preferred embodiment, either, or both of, the plunger cover and/or gripping portion can be selectively interchangeable; i.e., with other plunger covers and/or gripping portions to allow for the writing instrument to take on different and/or multiple looks, adding yet further value to the writing instrument. For example, it is anticipated herein that interchangeable plunger covers and/or gripping portions having different colors and/or textures and/or patterns, will be packaged with, or separately from, the writing instrument so as to allow the user to vary the look and feel of the writing instrument at will.

### BRIEF DESCRIPTION OF THE DRAWINGS

The above and other objects, features and advantages of the present invention will be readily apparent to those of ordinary skill in the art upon a reading of the following detailed description of presently preferred, but nonetheless illustrative, embodiments of the present invention when taken in conjunction with the accompanying drawings, in which:

FIG. 1 schematically illustrates an embodiment of the writing instrument according to the present invention;

FIG. 1a shows an exemplary embodiment of the upper end portion incorporated in the writing instrument;

FIG. 2 shows how the bendable upper end portion in FIG. 1 works;

FIG. 3 schematically illustrates another embodiment of the writing instrument according to the present invention;

FIG. 4 shows how the grasping portion in FIG. 3 works; and

FIG. 5 schematically illustrates another embodiment of the writing instrument according to the present invention;

FIG. 5a shows another exemplary embodiment of the upper end portion incorporated in the writing instrument; and

FIG. 6 shows a kit containing a writing instrument with interchangeable plunger covers and gripping portions in accordance with an exemplary embodiment of the present invention.

### DESCRIPTION OF THE PREFERRED EMBODIMENT

In the embodiments, same reference numerals refer to the similar elements throughout the drawings.

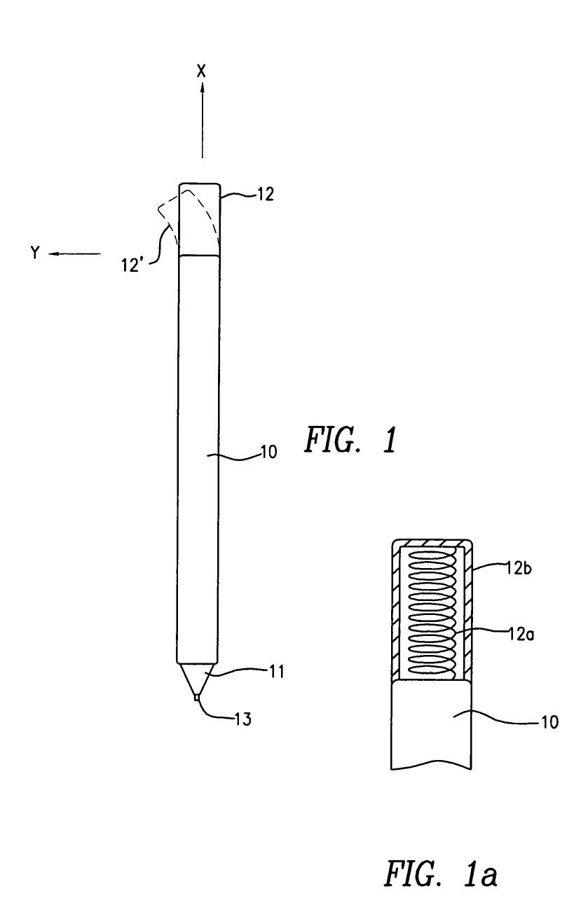

Referring now to FIG. 1, in which an embodiment of the writing instrument according to the present invention is schematically illustrated, the writing instrument may be a pen, a pencil, or any other writing device. It should be noted that if the device is a pencil, the below discussed partially resilient member at end portion 12 is not an eraser, and is not intended to be an eraser or to function as an eraser. An eraser is a substantially rigid structure when found at the end of a pencil; otherwise it would not be useable as an eraser. Continuing, the writing device generally comprises an elongated body 10, which may be generally cylindrical in shape, but can be in other shapes or configurations. The body comprises two opposite end portions 11 and 12 along its longitudinal axis “X”. The lower or first end portion 11 is provided with a writing point 13, which may be a graphite point in a pencil, or a ball in a ballpoint pen. The body 10 is generally made of a rigid material.

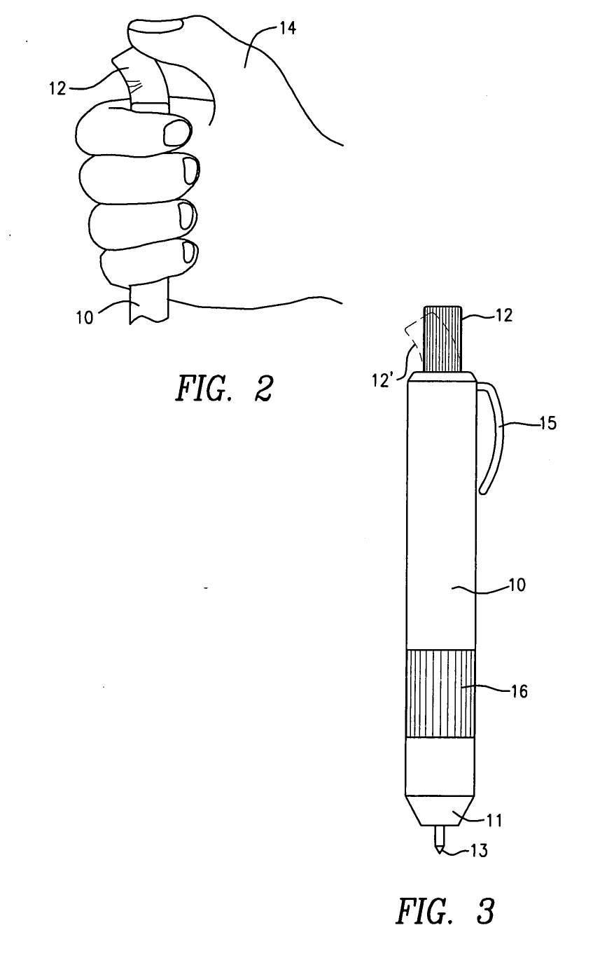

According to the teaching of the present invention, the upper or second end portion 12 of the body 10 is resiliently deformable. For example, when a thumb of a user presses on the upper end portion 12 in the “Y” direction of FIG. 1 (as shown in FIG. 2), the upper end portion 12 will partially deform in a direction “Y” lateral to the longitudinal axis “X” of the body 10 (as shown in dashed lines 12′ in FIG. 1). After the force from the thumb is relieved, with an inherent resiliency, the upper end portion 12 resumes its initial position. This partial deformation occurs without any unaesthetic permanent deformation of, or damage to, the writing instrument.

The upper end portion 12 may be made of a partially resilient material with certain inherent resiliency, such as, but not limited to, rubber. Alternatively, the upper end portion 12 may be any structure that is capable of bending under an external force and resuming its initial state when the force is removed. For example, it may comprise a coil spring 12a enclosed in a housing 12b, as shown in FIG. 1a.

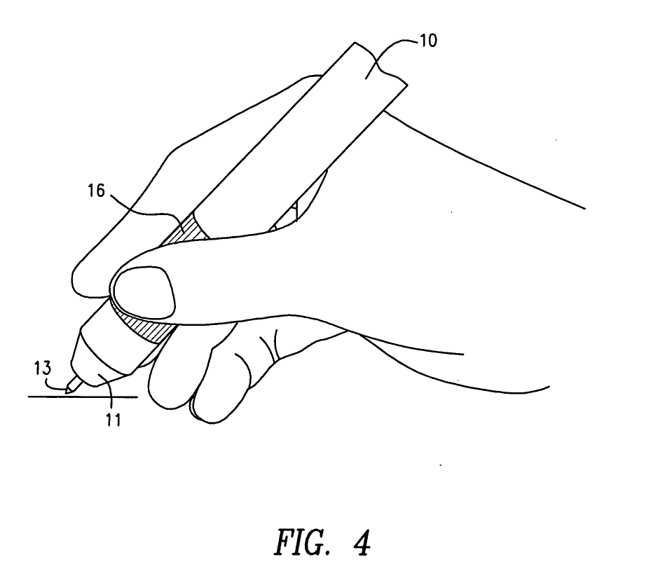

FIG. 3 illustrates another embodiment of the writing instrument according to the present invention. In this embodiment, the writing instrument comprises a plunger 12. When an external force is repeatedly applied on the plunger 12 in a longitudinal direction along the body 10, the plunger 12 drives the writing point 13 to reciprocally move between an exposed position and a retracted position. In the exposed position (as shown in FIGS. 3 and 4), the writing point 13 extends beyond the body 10 so that the instrument is ready for writing, while in the retracted position (not shown) the writing point 13 is completely kept inside the body 10.

According to the teaching of the present invention, the plunger 12 is capable of partially bending laterally (as shown in dashed lines 12′ in FIG. 3) under an external force laterally applied thereon, such as when it is pressed laterally by a thumb as shown in FIG. 2. Moreover, the plunger 12 is capable of resuming its normal position (shown as in solid lines in FIG. 3) after the external force is removed. The plunger 12 may be made of a partially resilient material with certain resiliency, such as a rubber, or as shown in FIG. 1a, or by any other means known in the art.

Preferably, the body 10 further comprises a grasping or holding portion 16 at which a user may grasp the writing instrument for writing (see FIG. 4). The grasping portion 16 is usually close to the lower end portion 11. Preferably, the grasping portion 16 is also made of a resilient material and has a non-slippery surface texture for facilitating the user to comfortably hold the body during writing. Preferably, the grasping portion 16 is made of the same resilient material as the plunger 12.

The body 10 may further comprise a clip 15 for attaching the writing instrument to an external item such as a pocket of a shirt.

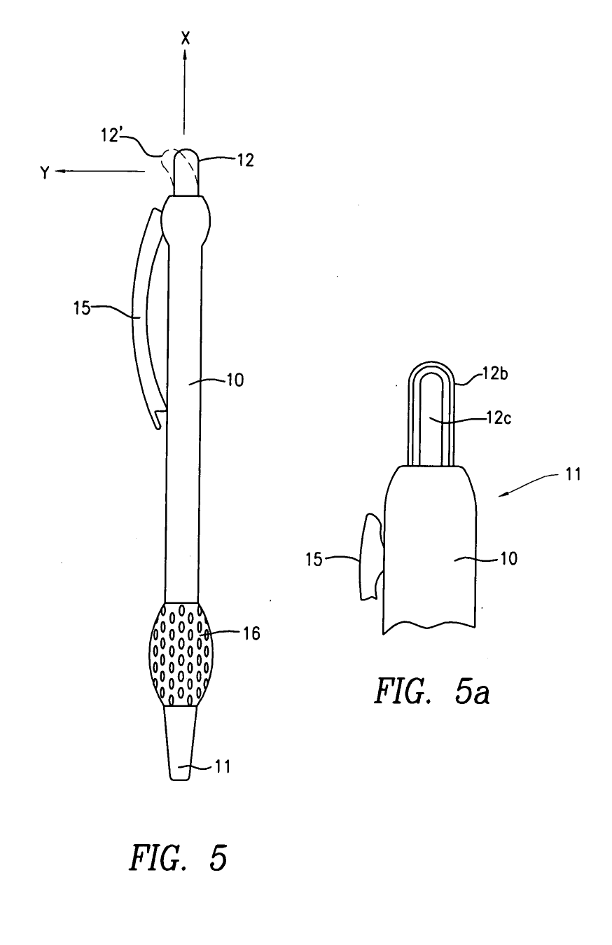

FIG. 5 illustrates another embodiment of the writing instrument of the present invention. In this embodiment, the writing instrument comprises a plunger 12, exemplary internals of which are depicted in FIG. 5a. The plunger 12 includes a plunger actuator member 12c, which is covered by a non-rigid plunger cover 12b. Also depicted in FIG. 5 are the body 10 and lower end portion 11 of the writing instrument, as well as its clip 15 and grasping portion 16.

In a preferred embodiment of the present invention, the plunger cover 12b may be formed of rubber or a deformable, rubber-like polymer, or some similarly resiliently deformable material.

In an embodiment, the plunger cover 12b and the grasping portion may be made of the same material, and may therefore have one, or all of, the same color, texture and/or pattern.

In another embodiment, the plunger cover 12b may be larger in size than the plunger actuator member.

In operation of the embodiment, when an external force is repeatedly applied in a longitudinal direction alone the longitudinal axis “X”, the plunger actuator member 12c drives the writing point (not depicted) to reciprocally move between an exposed position and a retracted position. Exposing the writing point extends the body 10 so that the instrument is ready for writing.

In accordance with the teaching of the present invention, when an external force is applied in a lateral direction, such as along lateral axis “Y”, the plunger cover 12b of the exemplary embodiment is partially deformed to the position represented by the dashed lines 12′ in FIG. 5. When the lateral force is subsequently removed, the plunger cover 12b then returns to approximately its non-deformed position as plunger 12, preferably aided by the underlying structure of the plunger actuator member 12c. Thus, the plunger cover 12b may be partially resiliently bent or compressed by lateral external forces.

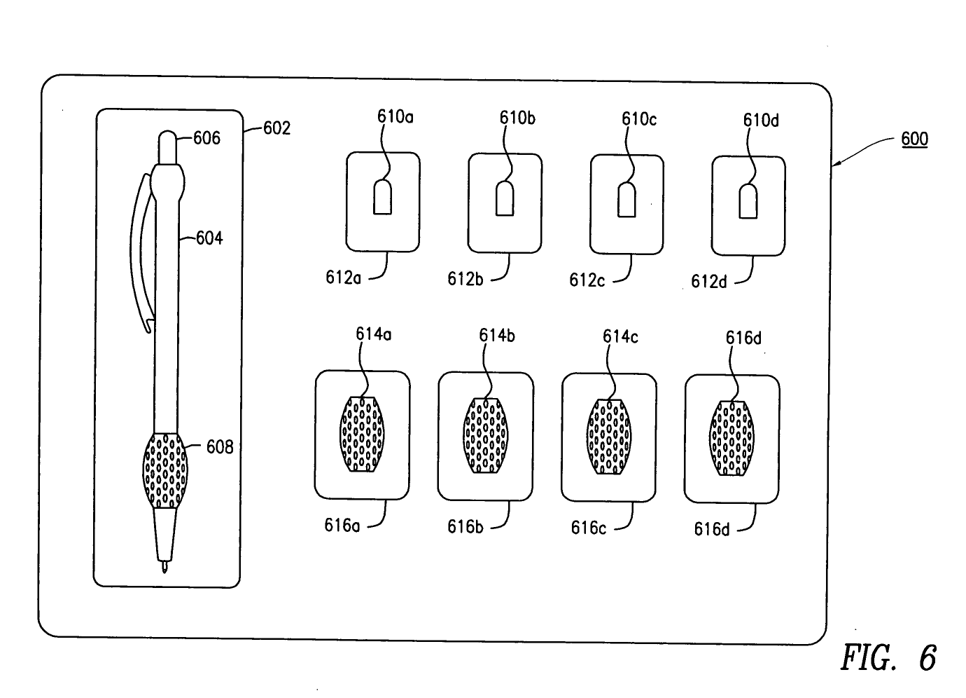

FIG. 6 illustrates another embodiment of the invention, a writing instrument kit 600. The writing instrument kit 600 preferably includes a writing instrument 604 in accordance with the present invention, having a plunger cover 606 and a gripping portion 608. The writing instrument may be packaged in a portion 602 of the writing instrument kit 600. The plunger cover 606 and gripping portion 608 preferable match in appearance. In an embodiment, the plunger cover 606 and gripping portion 608 match each other in color. In another embodiment they match in texture. In another embodiment they match in pattern. In other embodiments, the plunger cover 606 and gripping portion 608 match each other in combinations of color, texture and appearance in any manner.

In an embodiment of the writing instrument kit 600, the kit 600 further includes matching sets of plunger covers 610a-d and gripping portions 614a-d, each packaged in a portion 612a-d, 616a-d, respectively, of the writing instrument kit 600. In an embodiment, the plunger cover 606 and gripping portion 608 are able to be removed and replaced without damage to the writing instrument 604. Preferably, the plunger covers 610a-d and gripping portions 614a-d are provided in matching pairs, however, non-matching pairs are also anticipated herein. For example, plunger cover 610a matches gripping portion 614a, plunger cover 610b matches gripping portion 614b, plunger cover 610c matches gripping portion 614c, and plunger cover 610d matches gripping portion 614d. The matching may be in any manner as described above, such as color matching, texture matching, pattern matching, matching of all three elements (color, texture and pattern) and matching in any other way. In an embodiment, a user may remove the plunger cover 606 and/or gripping portion 608 from the writing instrument 604 and replace them, or either of them, with any one of the pairs of plunger covers 610a-d and gripping portions 614a-d, or any combination of these pairs, thereby providing writing instrument 604 with a different look.

In other embodiments, a different number of pairs of plunger covers 610a-d and gripping portions 614a-d may be provided in the writing instrument kit 600. Other kits having only one or more pairs of plunger covers 610a-d and gripping portions 614a-d are also included in the present invention.

Further, in other embodiments, separate kits (not shown) of single, or multiple, plunger covers and/or gripping portions, having varied or identical colors, textures and/or patterns, may be made available for a user of writing instrument 604 to purchase at a time after the purchase of writing instrument 604.

While preferred embodiments of the invention have been described in detail, it should be apparent that numerous modifications, adaptations and variations thereto are possible to a person skilled in the art without departing from the spirit of the present invention. It will thus be seen that the objects set forth above, among those made apparent from the preceding description, are efficiently attained, and since certain changes may be made in the above constructions without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention, which, as a matter of language, might be said to fall therebetween.

What is claimed is:

1. A writing instrument, comprising:
an elongated body having a first end portion with a writing point and a second end portion opposite to said first end portion;
a plunger member at least partially extending from said second end portion of said body, comprising a substantially rigid inner member and a non-rigid cover, said cover being over said inner member.

2. The writing instrument of claim 1, said cover being capable of resiliently deforming thereby giving the plunger the capability of partially deforming.

3. The writing instrument of claim 1, further comprising a grasping portion located along said elongated body proximate said first end portion, said grasping portion for being held by fingers of a user of said writing instrument when said user is writing with said writing instrument.

4. The writing instrument of claim 3, wherein said cover and said grasping portion are made of the same material.

5. The writing instrument of claim 3, wherein said cover and said grasping portion are the same color.

6. The writing instrument of claim 3, wherein said cover and said grasping portion have the same texture.

7. The writing instrument of claim 3, wherein said cover and said grasping portion have the same pattern.

8. The writing instrument of claim 1, wherein said plunger member is used for driving said writing point to reciprocally move between an exposed position out from said elongated body and a retracted position within said elongated body.

9. The writing instrument of claim 3, said grasping portion has a non-slippery surface.

10. A writing instrument comprising a body having a first end portion provided with a grasping portion and a writing point, and a second end portion opposite to said first end, wherein said second end portion comprises a plunger and plunger cover.

11. The writing instrument of claim 10, said plunger cover and said grasping portion made of a partially resilient material.

12. The writing instrument of claim 10, wherein said plunger is used for driving said writing point to move between an exposed position in which said writing point extends beyond said body and a retracted position in which said writing point is inside said body.

13. The writing instrument of claim 10, said plunger cover and said grasping portion are made of the same material.

14. The writing instrument of claim 10, said plunger cover and said grasping portion are the same color.

15. The writing instrument of claim 10, said plunger cover and said grasping portion are the same texture.

16. The writing instrument of claim 10, said plunger cover and said grasping portion have the same pattern.

17. The writing instrument of claim 10, said plunger cover being selectively removable from said writing instrument.

18. The writing instrument of claim 10, said grasping portion being selectively removable from said writing instrument.

19. A writing instrument kit, comprising:
a writing instrument comprising an elongated body having a first end portion with a writing point and a gripping portion and a second end portion opposite to said first end portion, and a plunger member at least partially extending from said second end portion of said body, comprising a substantially rigid inner member and a non-rigid cover, said cover being over said inner member;
at least one replacement gripping portion for use with said writing instrument; and
at least one replacement cover for use with said writing instrument.

20. The writing instrument kit of claim 19, said at least one replacement gripping portion being a plurality of replacement gripping portions and said at least one replacement cover being a plurality of replacement covers.

21. The writing instrument kit of claim 19, each one of said plurality of replacement gripping portions being paired with one of said plurality of replacement covers.

22. The writing instrument kit of claim 21, each of said paired replacement cover and replacement gripping portion being of the same color.

23. The writing instrument kit of claim 21, each of said paired replacement cover and replacement gripping portion being of the same texture.

24. The writing instrument kit of claim 21, each of said paired replacement cover and replacement gripping portion being of the same pattern.

25. The writing instrument kit of claim 21, wherein each of said pairs of said replacement covers and said replacement gripping portions are different in appearance from each other pair of said replacement covers and said replacement gripping portions in said kit.
